(19) United States
(12) Patent Application Publication
(10) Pub. No.: US 2026/0286922 A1
(43) Pub. Date: Sep. 24, 2026

(54) FUEL INJECTOR

(71) Applicant: PHINIA DELPHI LUXEMBOURG SARL, Belvaux (LU)

(72) Inventors: Richard ENTERS, Vineuil (FR); Frédéric SAUVAGE, Beaugency (FR); Nicolas CEZON, Ingre (FR)

(21) Appl. No.: 19/477,981

(22) PCT Filed: Apr. 23, 2024
(86) PCT No.: PCT/EP2024/061040

§ 371 Date: Oct. 23, 2025

(30) Foreign Application Priority Data
Apr. 26, 2023 (GB) 2306153.4

(51) Int. Cl. F02M 51/06

(52) U.S. Cl. CPC F02M 51/0664; F02M 2200/07; F02M 2200/8069

(57) ABSTRACT

A fuel injector includes a housing extending axially along an injector axis from a proximal end to a distal end and having a nozzle at the distal end; a pintle having an axially extending pintle shaft, the pintle being axially movable between an opened position and a closed position in which it closes the nozzle; and an armature arranged to be movable along the injector axis between a proximal position and a distal position and having an axial through-hole in which the pintle shaft is received. The armature includes an annular end wall portion defining a planar surface able to come at least partially into contact with a stopping surface in a rest position, the planar surface defining a contact plane transversal to injector axis. The annular end wall portion has inner and outer sides, each having an annular edge with the planar surface. Sides having their annular edge configured to come in contact with the stopping surface include a first surface, each first surface being at an angle inferior to or equal to 90° with the contact plane; and further comprise a second surface between their annular edge and their first surface, each second surface being at an angle superior to 90° with the contact plane. A projection of each second surface onto the contact plane is a ring of which the difference between the maximum radius and the minimum radius is smaller than 20 μm.

### TECHNICAL FIELD

The present invention generally relates to fuel injectors for internal combustion engines, more specifically to the contact geometry between an armature and a stopping surface within the injector.

### BACKGROUND ART

Fuel injectors are widely used with internal combustion engines to inject fuel into a combustion chamber of the engine. Such fuel injectors generally comprise a fuel delivery passage extending from a fuel pump, through the body of the injector, to an injector nozzle with a seal valve configured to atomize fuel into a combustion chamber when an injection event is triggered.

The injector body has an axial bore in which a shaft is slidably arranged, the shaft comprising at one end a sealing element able to cooperate with a valve seat of the seal valve to prohibit fuel flow. The shaft is typically translationally coupled with an armature configured to be actuated by a high-pressure spring and a solenoid, so as to open or close the seal valve and either enable or prohibit fuel flow into the combustion chamber. The range of motion of the armature is limited on one end by a pole piece and on the other end by a stopping surface often defined by a stop ring.

When a fuel injection is triggered, the armature and the sealing element are respectively moved away from the stop ring and the valve seat, unsealing the injector nozzle, and unloading a spray of high-pressure fuel in a cylinder of the engine. Conversely, when the fuel injection event ends, the armature and the sealing element are respectively snapped back against the stop ring and the valve seat, sealing the injector nozzle.

A proper operation of a fuel-injected engine requires that the fuel injectors and their controller allow for a timely, precise and reliable fuel injection. Indeed, it is well known that problems arise when the performance, or more particularly the timing and the quantity of fuel delivered by the injectors, diverges beyond acceptable limits. For example, injector performance deviation or variability will cause different torques to be generated between cylinders due to unequal fuel quantities being injected, or from the relative timing of such fuel injection.

As it is known, fuel injectors are typically controlled by generating drive pulses which are sent to the actuators of the fuel injectors. The amount of fuel injected depends on the length (duration) of the pulse sent to the actuator. Typically, an Engine Control Unit adjusts the pulse length based on characteristics of the injector to match a demand quantity of fuel to be injected.

However, characteristics of fuel injectors may vary over time for the same fuel injector, e.g. as a result of wear. In particular the opening and closing delays of an injector are known to vary over the course of its lifetime. Such variations often lead to unpredictable injector behavior and divergence beyond acceptable limits of injection timings and of quantities of fuel delivered.

### TECHNICAL PROBLEM

It is an object of the present invention to provide an injector that is less susceptible to divergence of injection timings and of quantities of fuel delivered over the course of its lifetime. More specifically, the present invention provides for unique armature geometries which limit hydraulic sticking.

This object is achieved by an injector armature to stop surface contact geometry as claimed in claim 1.

### GENERAL DESCRIPTION OF THE INVENTION

The present inventors have observed that one reason for the variation in opening delay of current injector designs is due to the increase in hydraulic sticking between the armature and the stop ring of an injector over its lifetime. Indeed, as a stop ring gets worn in by repeated impacts from its associated armature, their contact depth, i.e. the penetration distance of the armature inside the original volume of the stop ring, increases.

Due to the typical manufacturing process of an armature, its surface configured to come in contact with the stop ring typically has rounded corners. The inventors have found that with such an armature geometry, the effective area for hydraulic sticking rapidly increases with contact depth, thereby leading to an increase in injector opening delay.

The present invention provides a fuel injector comprising:
a housing extending axially along an injector axis from a proximal end to a distal end and having a nozzle at the distal end,
a pintle having an axially extending pintle shaft, the pintle being axially movable between an opened position and a closed position in which it closes the nozzle, and
an armature arranged to be movable along the injector axis between a proximal position and a distal position and having an axial through-hole in which the pintle shaft is received.

The armature comprises an annular end wall portion defining a planar surface able to come at least partially into contact with a stopping surface in a rest position, the planar surface defining a contact plane transversal to injector axis.

The annular end wall portion has inner and outer sides, each having an annular edge with the planar surface.

According to the invention, sides having their annular edge configured to come in contact with the stopping surface comprise a first surface, each first surface being at an angle inferior to or equal to 90° with the contact plane; and further comprise a second surface between their annular edge and their first surface, each second surface being at an angle superior to 90° with the contact plane. Furthermore, a projection of each second surface onto the contact plane is a ring of which the difference between the maximum radius and the minimum radius is smaller than 20 μm.

This armature geometry enables an improved control of the effective area of hydraulic sticking. Indeed, as the first surface is at an angle inferior or equal to 90° with the contact plane, its projection onto the contact plane is comprised in the projection of the second surface and the planar surface onto the contact plane. Hence, only the planar surface and the second surface contribute to the effective area for hydraulic sticking. In particular, the second surface may be shaped such that the effective area for hydraulic sticking is upper bounded and increases with contact depth in an easily predictable manner.

The control of the projection of each second surface onto the contact plane as a ring of prescribed width, i.e. smaller than 20 μm, allows controlling the effective area for hydraulic sticking to a maximum.

In embodiments, a projection of each second surface onto the contact plane is a ring of which the difference between the maximum radius and the minimum radius is smaller than 15 or 10 μm. Ideally, the size of the projected ring could be virtually reduced to zero, or say in practice a minimum size of this ring is around 2 to 5 μm.

In embodiments, in closed pintle position said armature is in distal position, respectively rest position, and wherein said armature is moved proximally to bring the pintle in opened position.

In embodiments, one or two sides of the annular end wall portion have their annular edge configured to come in contact with the stopping surface. That is, the inner edge, the outer edge or both edges may come into contact with the stopping surface.

In embodiments, the second surfaces are at an angle strictly superior to 90° with the contact plane, preferably between 110 and 160°.

In embodiments, the first surfaces and/or second surfaces are conical or cylindrical. That is, the annular end wall portion may form a cylindrical or conical wall, this in particular where both edges come into contact with the stopping surface.

In embodiments, the contact plane is normal to the injector axis.

In embodiments, the injector further comprises a stop ring and the stopping surface is a surface of the stop ring. The stop ring is preferably made from a non-magnetizable material. Alternatively, the stopping surface can be defined by an annular surface of the injector body, e.g. a shoulder.

In embodiments, the armature comprises an inner cylindrical portion having an axial through hole surrounding the pintle shaft, an outer cylindrical portion comprising the annular end wall portion, and a disk-shaped portion connecting the inner cylindrical portion to the outer cylindrical portion, the disk-shaped portion comprising a plurality of fuel channels enabling passage of fuel through the armature.

In embodiments, the outer cylindrical portion tapers towards the annular end wall portion. In embodiments, the width ratio of the outer cylindrical portion over the annular end wall portion may be of at least 3 or 4, and may range up to 8, 9 or 10.

In embodiments, the injector further comprises a pole piece limiting movement of the armature away from its rest position.

In embodiments, the injector further comprises a spring and/or a magnetic coil configured to actuate the armature.

In embodiments, the pintle further comprises a pintle perch, and wherein the armature is configured to apply a force along the injector axis on the pintle perch when moving away from its rest position.

### BRIEF DESCRIPTION OF THE DRAWINGS

Further details and advantages of the present invention will be apparent from the following detailed description of not limiting embodiments with reference to the attached drawing, wherein:

FIG. 1 shows a general longitudinal cross-sectional view of a fuel injector;

FIGS. 2a, 3a and 4a show longitudinal cross-sections of injectors comprising different embodiments of an armature design according to the present disclosure;

FIGS. 2b, 3b and 4b show enlarged views of region X of FIGS. 2a, 3a and 4a, respectively;

FIGS. 2c, 3c and 4c show lateral views of region X of FIGS. 2a, 3a and 4a, respectively;

FIGS. 2d, 3d and 4d show a diagram illustrating the annular end wall portion with the second surfaces and the annular edges of the embodiments of FIGS. 2a, 3a and 4a, respectively; and

FIGS. 2e, 3e and 4e are diagrams showing the evolution of the contact geometries of FIGS. 2d, 3d and 4d, respectively, as the stop rings get worn.

### DETAILED DESCRIPTION OF THE DRAWINGS

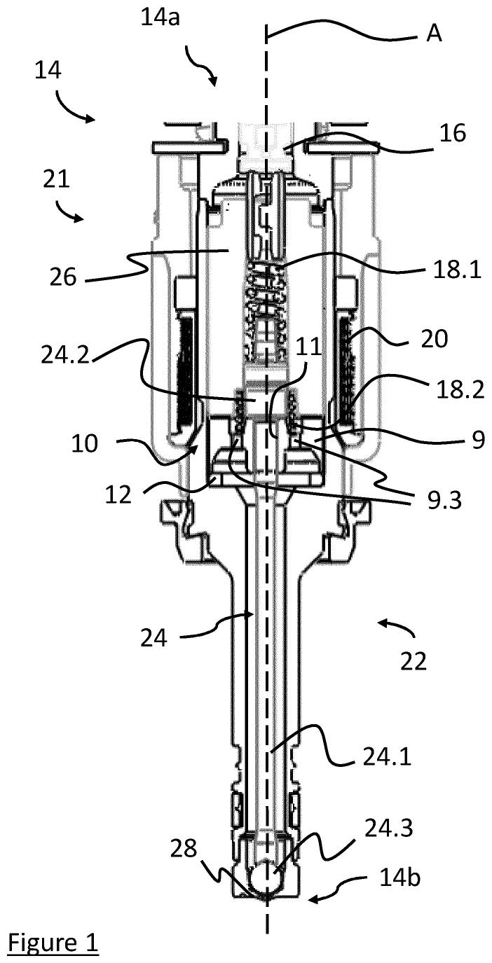

FIG. 1 schematically shows a fuel injector 14, which can be used in a combustion engine, in particular for injection of liquid fuel (diesel, gasoline, e-fuel, liquid biofuels etc.), either directly into the engine combustion chamber or indirectly. The fuel injector 14 comprises a housing 21 consisting of several parts (e.g. made of stainless steel), which are not explained here in detail. The housing 21 extends along an injector axis A from a proximal end 14a to a distal end 14b, where a nozzle 22 is disposed. An axial cavity 16 is formed inside the housing 21, which extends up to the nozzle 22 and is adapted for guiding fuel through the fuel injector 14. The injector 14 is typically fluidly coupled to an accumulator and a high-pressure fuel pump (not represented) at proximal end 14a, whilst the nozzle 22 is partially arranged in a cylinder of an engine (not represented) at distal end 14b.

The nozzle 22 can be closed by a pintle 24 (e.g. metal/stainless steel) that is disposed within the housing 21. The pintle 24 has an elongate pintle shaft 24.1 extending along injector axis A, from which an annular collar, referred to as pintle perch 24.2, projects radially. The pintle 24 is movable along injector axis A between an open position (not shown) and a closed position. In the closed position (shown in FIG. 1), a pintle head 24.3 at a distal end of the pintle 24 engages a nozzle seat 28 of the nozzle 22, thereby closing the nozzle 22. The pintle head 24.3 here is formed as a ball connected to the shaft 24.1 (other configurations are possible). If the pintle 24 moves proximally towards the open position, the pintle head 24.3 is lifted away from the nozzle seat 28, thereby opening the nozzle 22. A first spring 18.1 is disposed between the pintle perch 24.2 and a (magnetizable) pole piece 26 that is connected to the housing 21. The first spring 18.1 is a coil spring that is aligned along the injector axis A and exerts a force to distally bias the pintle 24, i.e. to bias the pintle 24 in a distal direction.

The above explanations on the internal injector design are only given for the sake of exemplification and shall not be construed as limiting. In particular other types of actuating means and spring configurations may be used.

The fuel injector 14 further comprises an armature 10 that has an annular shape and surrounds the pintle 24. The armature 10 has a body 10.1 with an axial through-hole in which the pintle shaft 24.1 is received. The armature 10, which is also typically metallic (e.g. stainless steel), can move axially along the pintle shaft 24.1, but radial movement with respect to the pintle 24 is greatly limited. Radially outside with respect to the through-hole, the armature 10 comprises a plurality of fuel channels in order to allow passage of fuel through the armature 10. The armature 10 is movable in the housing 21 along injector axis A between a proximal position and a distal position. In the distal position, the armature 10 is axially separated from the pole piece 26 and the pintle perch 24.2, and engages, with its annular end portion, a stop ring 12 that is interposed between the armature 10 and a portion of the housing 21. The stop ring 12 is made of non-magnetizable material, e.g., plastic or stainless steel. Conversely, in the proximal position, which is not shown in the figures, the armature is axially separated from the stop ring 12, and engages the pole piece 26 and the pintle perch 24.2. Hence, the range of motion of the armature 10 is limited on one end by the pole piece 26 and on the other end by the stop ring 12.

A magnetic coil 20 is disposed in the housing 21, radially outside the cavity 16, and is encapsulated in a plastic casing to provide electric isolation. When the magnetic coil 20 is energized, i.e. when current flows through the magnetic coil 20, a magnetic field is generated and enters the pole piece 26 and the armature 10, thereby pulling the armature 10 towards the pole piece 26, i.e. into the proximal position. A second spring 18.2 is disposed between the pole piece 26 and the armature 10 to distally bias the armature 10. Hence, when no magnetic field is acting on the armature 10, i.e. when the magnetic coil 20 is not energized, the armature 10 is kept in the distal position by the second spring 18.2.

When the armature 10 moves towards the proximal position it engages the pintle perch 24.2 before it engages the pole piece 26, thereby transferring an axial force to the pintle 24 and moving the latter into the open position. Conversely, when the armature 10 moves towards the distal position it releases the pintle perch 24.2, which is then distally biased by the first spring 18.1 and forced in the closed position.

Hence, when a fuel injection is triggered, the magnetic coil 20 is energized and the armature 10/pintle head 24.3 are respectively lifted away from the stop ring 12/nozzle seat 28, thereby unsealing the injector nozzle 22 and unloading a spray of high-pressure fuel in the cylinder. Conversely, when the fuel injection event ends, the magnetic coil 20 is de-energized, and the armature 10/pintle head 24.3 are respectively snapped back against the stop ring 12/nozzle seat 28, thereby sealing the injector nozzle 22.

### Invention

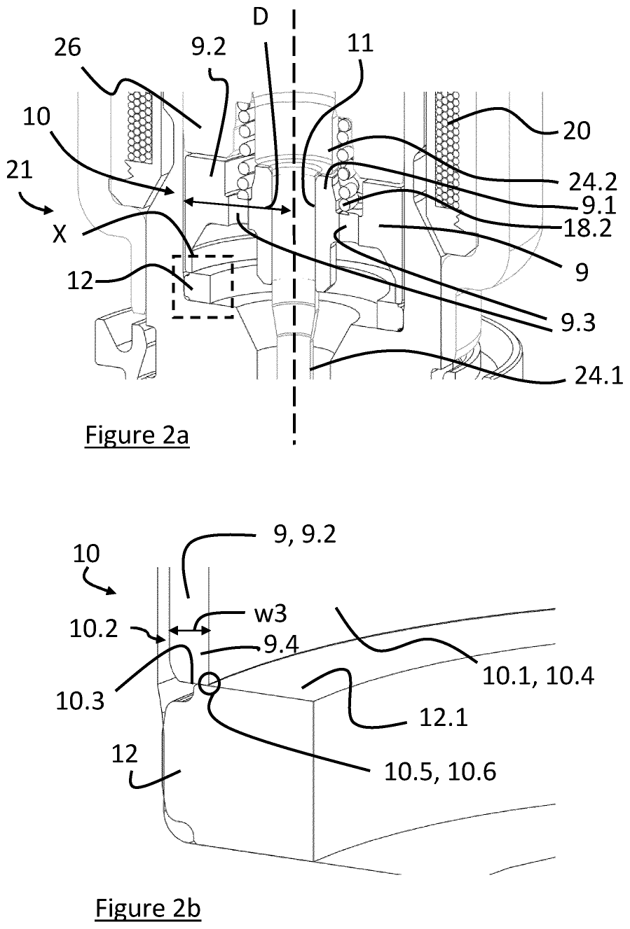

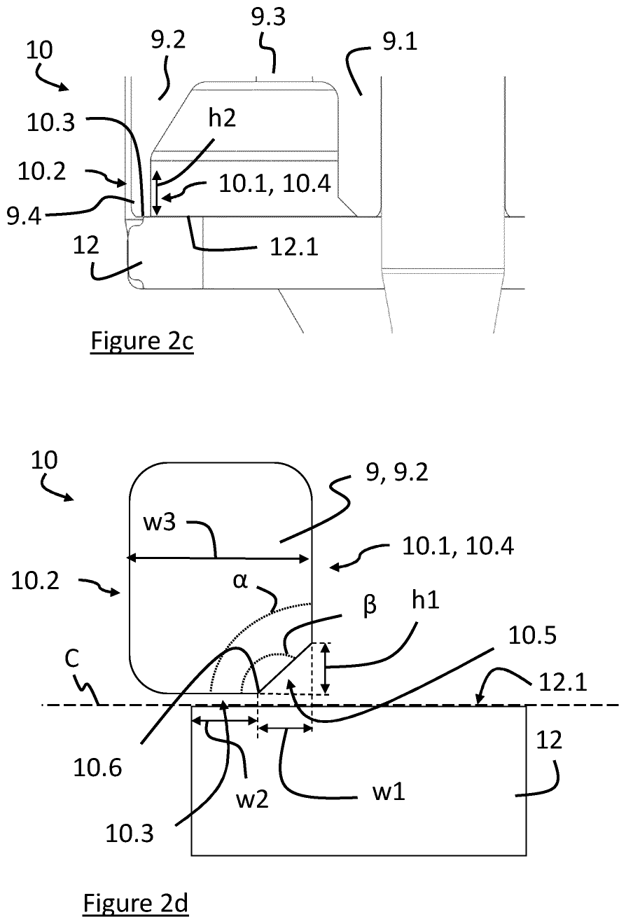

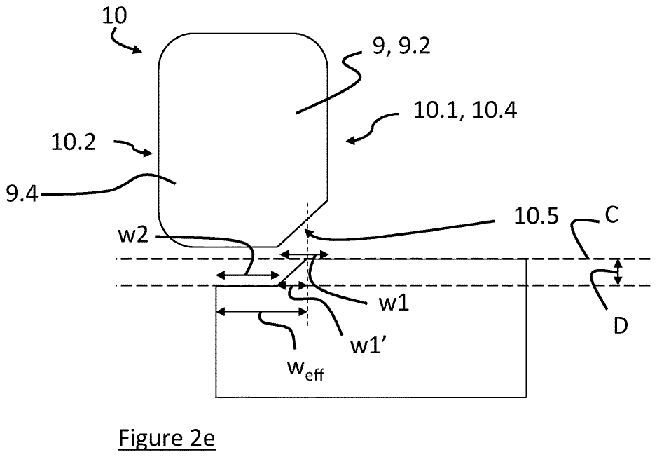

As previously mentioned, it is essential to have precise injection timings and duration throughout the lifetime of the injector 14. To this end, the inventors have designed improved armature 10 geometries which strongly limit the hydraulic sticking between a stopping surface, here defined by stop ring 12, and armature 10 to a. The sets of FIGS. 2a-d, 3a-d and 4a-d show three different embodiments of injectors 14 having such armature 10 geometries.

In particular, FIGS. 2a, 3a and 4a show longitudinal cross sections of the three different embodiments of injectors 14. The embodiments of injectors differ only by the design of their armature 10, 10′, 10″, and otherwise present the same elements as the injector 14 of FIG. 1. The different armature designs are similar in that they are all of generally annular shape. The armature designs also all comprise a body 9 comprising an inner cylindrical portion 9.1 having the axial through hole surrounding the pintle shaft 24.1, the inner cylindrical portion 9.1 being configured to engage the pintle perch 24.2 when the armature 10, 10′, 10″ is moved proximally. The armature body further comprises an outer cylindrical portion 9.2 having a proximal end configured to engage the pole piece 26 when the armature 10, 10′, 10″ is moved proximally, and a distal end with an annular end wall portion 9.4 configured to engage the stop ring 12 in rest position, and hence when the armature 10, 10′, 10″ moves distally to return to the rest position. The armature body finally here also comprise a disk-shaped portion 9.3 connecting the inner cylindrical portion 9.1 to the outer cylindrical portion 9.2, the disk-shaped portion 9.3 preferably comprising a plurality of fuel channels, that communicate with the cavity 16 in order to allow passage of fuel through the armature 10.

FIGS. 2b, 3b and 4b, and 2c, 3c and 4c show enlarged views of region X—i.e. the contact interface between annular end wall portion and stop ring—of FIGS. 2a, 3a and 4a, respectively. In particular, these figures show the distal end of the outer cylindrical portion 9.2 of the different armature designs. Each annular end wall portion 9.4 comprises an annular planar surface 10.3, 10′.3, 10″.3 able to come at least partially into contact with a stopping surface 12.1 of the stop ring 12, the planar surfaces 10.3, 10′.3, 10″.3 defining a contact plane normal to the injector axis A. Each annular end wall portion 9.4 further comprises two annual sides, i.e. an inner annular side 10.1, 10′.1, 10″.1 and an opposite outer annular side 10.2, 10′.2, 10″.2. Each annular side defines an annular edge 10.6, 10′.6, 10″.6 with the planar surface 10.3, 10′.3, 10″.3.

Annular sides having their annular edge 10.6, 10′.6, 10″.6 configured to come in contact with the stopping surface, i.e. annular side 10.1, 10′.1, 10′.2 and 10″.2, comprises a first surface 10.4, 10′.4, 10″.4 and a second surface 10.5, 10′.5, 10″.5 arranged between their annular edge 10.6, 10′.6, 10″.6 and their first surface 10.4, 10′.4, 10″.4. The annular edges 10.6, 10′.6, 10″.6 and second surfaces 10.5, 10′.5, 10″.5 are represented on FIGS. 2d, 3d and 4d, which respectively correspond to the embodiments of FIGS. 2a-c, 3a-c and 4a-c. It is noted that FIGS. 2d, 3d and 4d are not to scale to better illustrate the second surfaces 10.5, 10′.5, 10″.5 and the annular edges 10.6, 10′.6, 10″.6.

When the stop ring 12 is intact (i.e. new/non-worn condition), the effective area for hydraulic sticking corresponds to the area of the planar surface 10.3, 10′.3, 10″.3 in contact with the stop ring. Over time, the stop ring gets worn in by repeated impacts from the armature, increasing the contact depth D. FIGS. 2e, 3e and 4e show the evolution of the contact geometries of FIGS. 2d, 3d and 4d, respectively, as the stop rings get worn. As the contact depth increases, an increasing portion of the second surface 10.5, 10′.5, 10″.5 enters contact with the stop ring, increasing the effective area for hydraulic sticking represented by w_{eff}. More specifically, the effective area for hydraulic sticking represented by w_{eff} is equal to the sum of the original area of the planar surface 10.3, 10′.3, 10″.3 in contact with the intact stop ring represented by w2, and the projected area of the portion of the second surface 10.5, 10′.5, 10″.5 in contact with the stop ring onto the contact plane C represented by w1′.

Accordingly, each second surface 10.5, 10′.5, 10″.5 is dimensioned such that its projection onto the contact plane C is a ring of which the difference between the maximum radius and the minimum radius is smaller than 20 μm, preferably smaller than 15 or 10 μm. As shown on FIGS. 2d, 3d, 4d, this difference in radii corresponds to the width w1 of the second surface 10.5, 10′.5, 10″.5. Further, the height h1 of the second surface 10.5, 10′.5, 10″.5 can be defined as the maximum distance along the injector axis A between two of its points. Remarkably, each first surface 10.4, 10′.4, 10″.4 is at an angle α equal to 90° (or less) with the contact plane C, whilst each second surface 10.5, 10′.5, 10″.5 is at an angle β greater than 90°, here. e.g. 120°, with the contact plane C.

When the first surface 10.4, 10′.4, 10″.4 is at an angle inferior or equal to 90° with the contact plane C, its projection onto the contact plane C is comprised in the projection of the second surface 10.5, 10′.5, 10″.5 and the planar surface 10.3, 10′.3, 10″.3 onto the contact plane C. Hence, when the contact depth D is superior or equal to the height h1 of the second surface 10.5, 10′.5, 10″.5, the effective area for hydraulic sticking represented by w_{eff} stops increasing. The effective area for hydraulic sticking represented by w_{eff} thus has an upper bound dependent on the width w1 of the second surface 10.5, 10′.5, 10″.5, and extreme variations of opening delay are prevented.

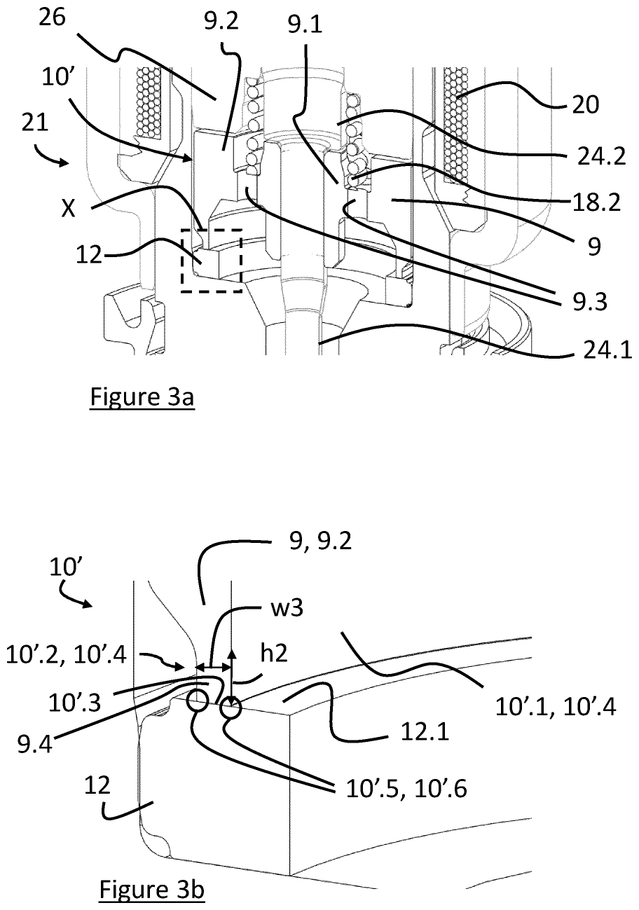

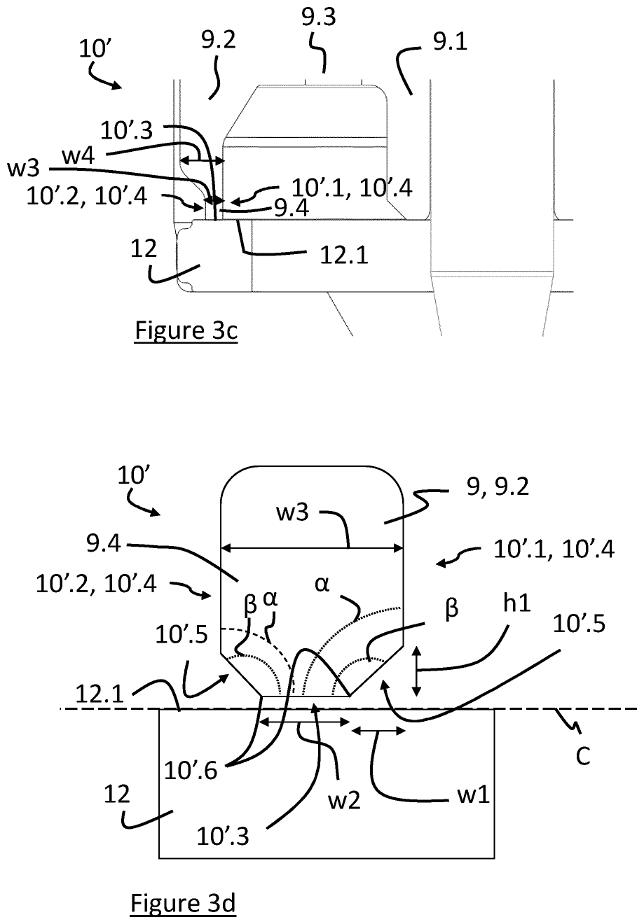

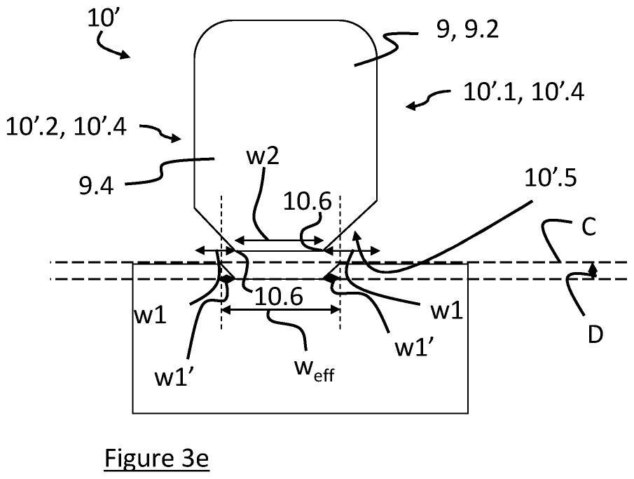

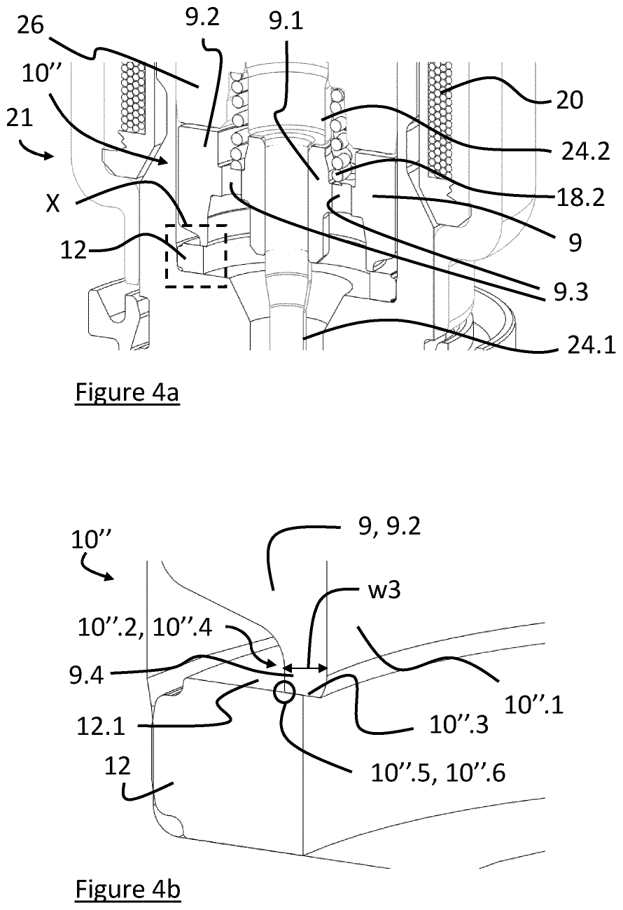

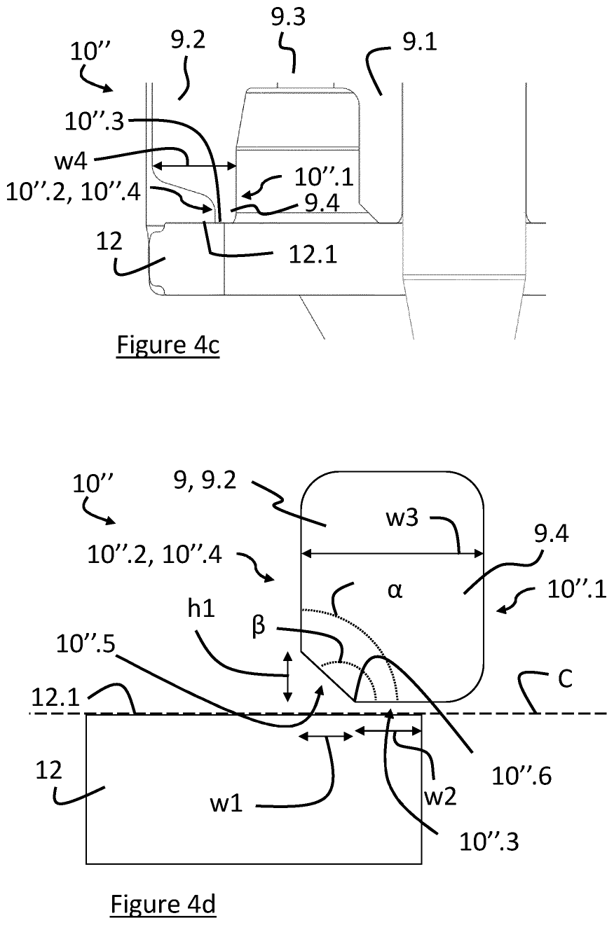

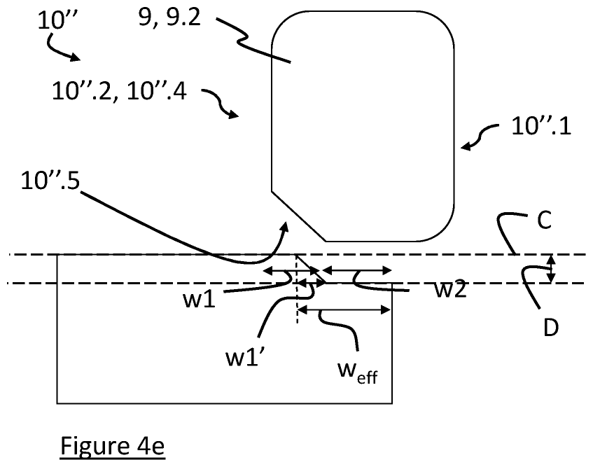

More specifically, for the embodiments corresponding to FIGS. 2e and 4e, we have w2≤w_{eff}=w2+w1′≤w2+w1 as w1′≤w1. For the embodiment corresponding to FIG. 3e, we have w2≤w_{eff}=w2+2*w1′≤w2+2*w1 as w1′≤w1.

It may be noted that the annular end wall portion 9.4 typically has a width w3 which is comparatively much smaller than outer cylindrical portion, even in the portion situated just above.

Referring for example to the embodiment of FIG. 3c, the annular end wall portion 9.4 is a cylindrical wall and its width w3 is smaller than the portion just above with width w4, the portion above having event a greater width. In embodiments, the ratio w4/w3 may be of about 3 to 10 or 4 to 8.

### Preferred Embodiments

In exemplary, non-limitative embodiments of the invention, the armature 10, 10′ 10″ may implement one or more of the following dimensions:
the width w2 of the original area of the planar surface 10.3, 10′.3, 10″.3 in contact with the intact stopping surface (or here stop ring) is comprised between 100 and 250 μm,
the outer diameter of the outer cylindrical portion 9.2 is comprised between 9 and 11 mm,
the outer diameter of the outer cylindrical portion 9.2 has a width between 9 and 11 mm;
the annular end wall portion 9.4 has a maximal width w3 comprised between 100 to 200 or 250 μm;
the angle α between the first surface and the contact plane C is between 20° and 70°,
the angle β between the second surface and the contact place C is between 110° and 160°,
the width w1 of the second surface 10.5, 10′.5, 10″.5 is smaller than 20 μm;
the height h1 of the second surface 10.5, 10′.5, 10″.5 is smaller than 55 μm;
the height h2 of the annular end wall portion 9.4 may be in the range 25 to 200 μm.

To sum up, the present invention proposes an improved interface design of the distal, annular end wall portion 9.4 of the armature 9.

According to the invention, each of the so-called second surface 10.5, 10′.5, 10″.5 is dimensioned such that its projection onto the contact plane C is a ring of which the difference between the maximum radius and the minimum radius is smaller than 20 μm, preferably smaller than 15 or 10 μm.

It may be noted that the drawings are not to scale, accordingly w1 appears much longer than it is. It should be kept in mind that the dimension of 20 μm prescribed by the invention corresponds to a microscopic range and represents a purposive design/constructive feature. It is obtained by the manufacturing process. Moreover, this value is optimized in order to improve the wear/performance trade-off of the injector, as explained below. thanks to the invention, it is possible to maintain consistent injector efficiency regardless of wear between the armature and the stop ring. The wear increases the phenomenon of hydraulic sticking, which lowers the efficiency of the injector by increasing its opening delay. The injector thus needs more time to get from the closed to the open position, retarding the delivery of fuel in the engine and disturbing the fuel supply mechanism. Limiting the radius of the projection of the second surface to 20 μm precisely limits the maximum contact surface between the components of the injectors without negatively affecting its efficiency or excessively increasing stress and wear.

From the manufacturing point of view, the annular end wall portion 9.4 requires several steps to obtain the desired geometry.

An exemplary method of shaping the annular end wall portion 9.4 comprises the steps of:
machining, one after another, the opposite sides of the annular wall 9 to form the inner and outer sides 10.1 and 10.2;
grinding the free end of annular wall 9 to form planar surface 10.3
then forming each second surface 10.5 by a deburring process (e.g. tumbling or or similar).

In case the annular wall 9 includes only on second surface 10.5, as in the embodiment of FIG. 2 the rounded edge connecting the outer side to the planar side 10.3 is may be machined at the same time as the respective outer side 10.1 or 10.2.

In embodiments, each second surface 10.5 may be formed together with the respective side 10.1 and/or 10.2.

Regarding more specifically the embodiments shown in the figures, where the annular wall is cylindrical, the outer sides are thus first machined 10.1 and 10.2 and centered on the longitudinal axis, then the planar surface 10.3 is processed at 90°.

In case the annular wall should comprise two second surfaces 10′.5, as in FIG. 3, after grinding the planar surface two 90° edges exist, which are thus removed by the subsequent tumbling of the second surfaces 10′.5.

In case the annular wall should comprise only one second surface 10.5 as in FIGS. 2 and 4, the grinding of the planar surface 10.3 is done to keep the rounded edge, so leaving one sharp edge at 90°, that is then removed by the following grinding of the second surface 10.5

Preferably, grinding of the planar surface 10.3 is done by so-called double disc grinding, whereby the armature top surface (facing pole piece) is simultaneously processed.

It may be noted that whereas the method here proposes a separate step for forming the second surface 10.5 such as the deburring process, this may not always be required. Depending on the machining of the sides 10.1 and 10.2 and of the planar surface 10.5, a second surface 10.5, 10′.5 may already exist at the end of this machining, having a projection of a few micrometers, e.g. around 3, 4 or 5 μm.

1. A fuel injector comprising:
a housing extending axially along an injector axis from a proximal end to a distal end and having a nozzle at the distal end,
a pintle having an axially extending pintle shaft, the pintle being axially movable between an opened position and a closed position in which it closes the nozzle,
an armature arranged to be movable along the injector axis between a proximal position and a distal position and having an axial through-hole in which the pintle shaft is received,
wherein the armature comprises an annular end wall portion defining a planar surface able to come at least partially into contact with a stopping surface in a rest position, the planar surface defining a contact plane transversal to injector axis;
wherein the annular end wall portion has inner and outer sides, each having an annular edge with the planar surface;
wherein sides having their annular edge configured to come in contact with the stopping surface comprise a first surface, each first surface being at an angle inferior to or equal to 90° with the contact plane; and further comprise a second surface between their annular edge and their first surface, each second surface being at an angle superior to 90° with the contact plane,
wherein a projection of each second surface onto the contact plane is a ring of which the difference between the maximum radius and the minimum radius is smaller than 20 μm.

2. Fuel injector according to claim 1, wherein a projection of each second surface onto the contact plane is a ring of which the difference between the maximum radius and the minimum radius is smaller than 15 μm.

3. Fuel injector according to claim 1, wherein in closed pintle position said armature is in distal position, respectively rest position, and wherein said armature is moved proximally to bring the pintle in opened position.

4. Fuel injector according to claim 1, wherein one or two sides of the annular end wall portion have their annular edge configured to come in contact with the stopping surface.

5. Fuel injector according to claim 1, wherein second surfaces are at an angle strictly superior to 90° with the contact plane.

6. Fuel injector according to claim 1, wherein first surfaces and/or second surfaces are conical or cylindrical.

7. Fuel injector according to claim 1, wherein the contact plane is normal to the injector axis.

8. Fuel injector according to claim 1, wherein
the outer cylindrical portion tapers towards the annular end wall portion;
the annular end wall portion is a cylindrical wall having a width w3, which is smaller than the width w4 of the adjacent armature portion; and
a ratio w4/w3 is of 3 to 10.

9. Fuel injector according to claim 8, wherein a minimum height of the cylindrical wall having a width w3 is between 25 and 200 μm from the planar surface.

10. Fuel injector according to claim 1, further comprising a stop ring and wherein the stopping surface is a surface of the stop ring.

11. Fuel injector according to claim 1, wherein the armature comprises an inner cylindrical portion having an axial through hole surrounding the pintle shaft, an outer cylindrical portion comprising the annular end wall portion, and a disk-shaped portion connecting the inner cylindrical portion to the outer cylindrical portion, the disk-shaped portion comprising a plurality of fuel channels enabling passage of fuel through the armature.

12. Fuel injector according to claim 11, wherein the outer cylindrical portion tapers towards the annular end wall portion.

13. Fuel injector according to claim 1, further comprising a pole piece limiting movement of the armature away from its rest position.

14. Fuel injector according to claim 1, further comprising a spring and/or a magnetic coil configured to actuate the armature.

15. Fuel injector according to claim 1, wherein the pintle further comprises a pintle perch, and wherein the armature is configured to apply a force along the injector axis on the pintle perch when moving away from its rest position.

16. A method of manufacturing an armature of a fuel injector according to claim 1, comprising:
providing an armature comprising an inner cylindrical portion having an axial through hole configured to surround the pintle shaft and to engage the pintle perch; an outer cylindrical portion having a proximal end configured to engage the pole piece and a distal end with an annular end wall portion configured to engage a stop surface in rest position; and a disk-shaped portion connecting the inner cylindrical portion to the outer cylindrical portion;
machining, one after another, the opposite sides of the annular wall to form inner and outer sides;
grinding the free end of annular end wall portion to form a planar surface; and
forming one or two second surface by a deburring process.

17. Fuel injector according to claim 2, wherein the difference between the maximum radius and the minimum radius is smaller than 10 μm.

18. Fuel injector according to claim 5, wherein the second surfaces are at an angle between 110 and 160° with the contact plane.

19. Fuel injector according to claim 8, wherein a ratio w4/w3 is of 4 to 8.

20. Fuel injector according to claim 10, wherein the stop ring is made from a non-magnetizable material.
